(19) United States
(12) Patent Application Publication
(10) Pub. No.: US 2015/0271135 A1
(43) Pub. Date: Sep. 24, 2015

(54) SESSION-AWARE NETWORK ADDRESS TRANSLATION TRAVERSAL METHOD

(71) Applicant: National Chiao Tung University, Hsinchu City (TW)

(72) Inventors: CHIEN-CHAO TSENG, HSINCHU CITY (TW); MING-HUNG WANG, KAOHSIUNG CITY (TW); CHIA-LIANG LIN, PINGTUNG COUNTY (TW)

(21) Appl. No.: 14/658,560

(22) Filed: Mar. 16, 2015

(30) Foreign Application Priority Data
Mar. 18, 2014 (TW) 103110106

(51) Int. Cl. H04L 29/12; H04L 29/08

(52) U.S. Cl. CPC H04L 61/2564; H04L 67/141

(57) ABSTRACT

The session-aware NAT traversal method is used to establish network communication between two hosts, wherein a first and a second host are located behind a first and a second NAT router, respectively. First, these hosts conduct a standard NAT traversal to establish a session. Then, the second host sends a registration request message to the first NAT router for session registration. Upon receiving the registration request message, the first NAT router generates a session ID for this session and replies to the second host. As the second host moves to a private network behind a third NAT router, the second host only needs to send a new registration request message with the session ID to the first NAT router. The first NAT router observes a new mapped address of the second host and allows inbound traffic from the new mapped address without further NAT traversal.

This application claims priority for Taiwan patent application no. 103110106 filed on Mar. 18, 2014, the content of which is incorporated by reference in its entirely.

### FIELD OF THE INVENTION

The present invention is related to a network transmission mechanism, particularly referring to session-aware network address translation traversal method.

### BACKGROUND OF THE INVENTION

Network Address Translation (NAT) is a solution to alleviate the exhaustion of IPv4 address. By modifying network address fields in packet header when packets pass through a NAT-capable router, the NAT router remaps a given address realm into another, while providing transparent routing for the hosts behind a NAT router. The nature of NAT causes a problem known as NAT traversal problem, which is a barrier to P2P applications.

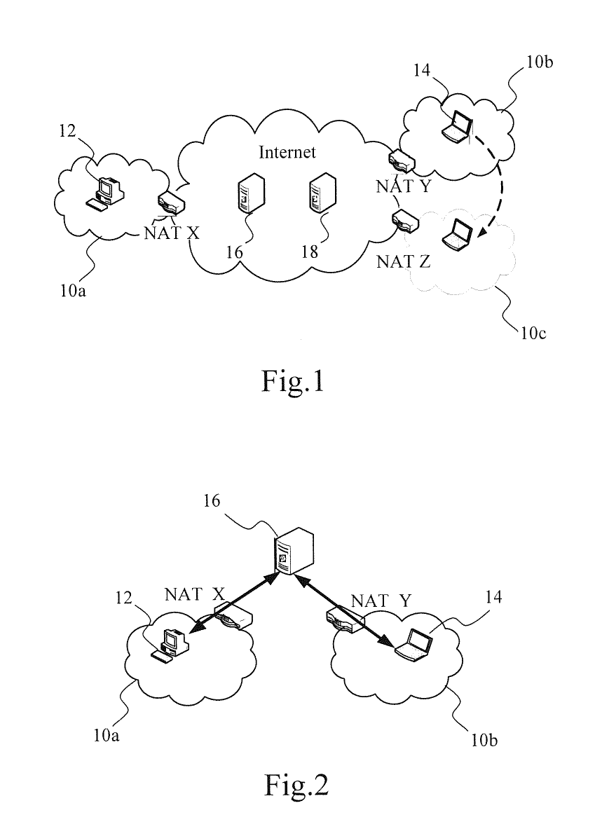

Assume there are two hosts, refer to FIG. 1, whereby host 12 is located within a private network 10a behind the NAT router X and host 14 is located within another private network 10b behind the second NAT router Y respectively. These hosts are required to conduct NAT traversal, a process to traverse NAT routers for establishing direct communication. First, these hosts utilize Session Traversal Utilities for NAT (STUN) protocol to discover their respective mapped addresses via a STUN server 16. A mapped address is an public IP address along with a port number allocated by a NAT router for an outbound session attempting from a host behind the NAT router; secondly, both hosts exchange their mapped addresses through a signaling server 18; thirdly, these hosts establish a session by using the mapped addresses acquired from the second step as their destination addresses. This procedure is also known as the hole-punch process. However, if the host 14 moves to another private network 10c behind another NAT router Z, the ongoing session with the host 12, depending on the filtering behaviors of the NAT routers, may be disrupted. Thus, the packets originating from the new mapped address on the NAT router Z for the host 14 was discarded by the NAT router X, unless the NAT router X is a full-cone NAT router. Therefore, the change of the mapped address compels the two hosts to re-conduct a NAT traversal process to resume the disrupted session.

For this reason, this invention proposes the session-aware NAT traversal method to overcome the abovementioned problems of the conventional method.

### SUMMARY OF THE INVENTION

The main objective of the present invention is to provide a session-aware NAT traversal method, which is used to establish a network communication between the first and second hosts located behind different NAT routers, wherein the second host registers for a session with the NAT router of the first host after the NAT traversal is done for the first time. Meanwhile, the NAT router of the first host assigns a session ID for this session and returns it to the second host. When the second host moves to another private network, it uses this session ID to register with the NAT router of the first host again to restore the session. This method exempts the two hosts from re-conducting the NAT traversal process and thus shortens handoff latency.

Another objective of the present invention is to provide a session-aware NAT traversal method, wherein the NAT router maintains a session record including a session ID and the mapped address for each session between a fixed host and a mobile host. With the session record, the NAT router of the fixed host is able to learn that the communications before and after the movement of the mobile host are belongs to the same session. After the mobile host moves, the mobile host sends another registration request with the session ID to the mapped address of the fixed host. Upon receiving the message, the NAT router of the fixed host observes that the mapped address of the mobile host for the existing session has changed to the source IP address and port number of the request message. The NAT router updates the session record and allows the packets from the new mapped address of mobile host to pass through without any further NAT traversal process.

A further objective of the present invention is to provide a session-aware NAT traversal method, wherein whenever the NAT router of the fixed host receives a registration request with an existed session ID, it not only updates the mapped address field in the session record but also sends a registration reply message carrying the updated mapped address to the mobile host. Thus, the mobile host resumes the session using the new (post-handoff) mapped address without the help of a STUN server.

### BRIEF DESCRIPTION OF THE ILLUSTRATIONS

FIG. 1: Architecture of the network system

FIG. 2: Two hosts acquiring the mapped addresses through the STUN server

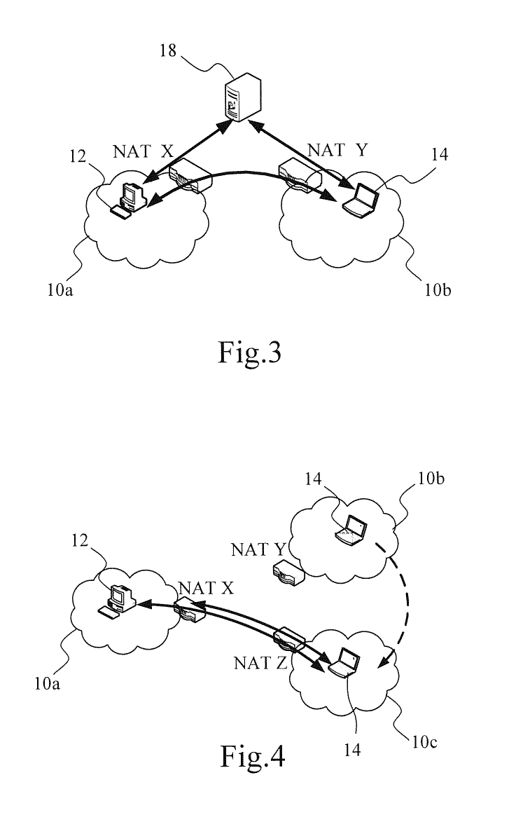

FIG. 3: Two hosts exchanging mapped addresses and the hole punching process

FIG. 4: The mobile host moving to another private network and resuming the disrupted session

### DESCRIPTION OF THE IMPLEMENTATION METHOD

This invention provides a session-aware NAT traversal method. Refer to FIG. 1 for the architecture of the network system. The network system comprises of the host 12, the host 14, the NAT router X, the NAT router Y, the NAT router Z, at least one STUN server 16 and at least one signaling server 18. The host 12 and the host 14 are located within the private network 10a behind the NAT X and the private network 10b behind the NAT Y respectively. The STUN server 16 and the signaling server 18 are located within a public network (the Internet).

The host 12 and the host 14 are respectively located behind different NAT routers. Therefore, the NAT traversal is required to enable the communication between the two hosts. If the host 14 is originally located within the private network 10b behind the NAT router Y but moves to the private network 10c behind the NAT router Z later, the communication between the host 12 and the host 14 need to be re-established. Refer to FIG. 2. The host 12 and the host 14 have private IP addresses within the private network 10a and the private network 10b respectively, but the two hosts do not have public IP addresses (due to both are located behind the NAT routers). Therefore, the host 12 and the host 14 have to acquire the mapped addresses (i.e. the IP addresses and ports) assigned to them by the NAT router X and the NAT router Y respectively. The host 12 sends an echo request message from its address IPa.Pa to the STUN server 16. Because the host 12 is located behind the NAT router X, the NAT router X will route this message. During the route process, the NAT router X will allocate a mapped address IPx.Px that serves as IPa.Pa (any packet reaches IPx.Px later will be re-directed to IPa.Pa) and forward the echo request message from the IPx.Px to the STUN server 16. After the STUN server 16 received the echo request message, the STUN server 16 sends an echo response message back to the host 12, wherein the echo response message, to the host 12, carries the mapped address IPx.Px that was obtained from the NAT router X. When the host 12 receives the echo response message, the host 12 learns that its own mapped address assigned by NAT router X is IPx.Px. Similarly, the host 14 uses the same way learns from the message replied from the STUN server 16 that its own mapped address assigned by NAT router Y is IPy.Py.

Particularly, the host 12 and the host 14 can use two different STUN servers 16 to acquire their own mapped addresses. The STUN server 16 may be a group of servers for the hosts that support the STUN protocol.

The abovementioned method only describes one way to acquire mapped addresses. Besides the abovementioned method, if the NAT routers support Internet Gateway Device (IGD) protocol, hosts may use IGD protocol to acquire their mapped addresses from NAT routers instead of the STUN servers.

Refer to FIG. 3, wherein the host 12 and the host 14 use the signaling server 18 to exchange their mapped addresses. The host 12 may send an INVITE message that carries its own mapped address IPx.Px to the host 14 through the signaling server 18. Upon receiving the INVITE message, the signaling server 18 processes and forwards the message to the host 14. Similarly, the host 14 sends a response message that carries its own mapped address IPy.Py to the host 12 through the signaling server 18. After the signaling server 18 forwards the response message to the host 12, both hosts know the mapped address of the opposite party.

Next, the host 12 and the host 14 perform the hole-punching process by transmitting packets directly to the mapped address of the opposite party (host 12 to IPy.Py and host 14 to IPx.Px). The hole-punching process is completed when the host 12 and the host 14 receive packets from the opposite party.

The aforementioned signal server 18 may also be a group of servers.

After the NAT traversal process is completed, the host 14 sends a registration request message to the NAT router X. Thus, the NAT router X assigns a unique session ID for this session and maintains a session record including the session ID and the mapped address IPy.Py. The session record also includes a transport layer protocol. Then, the NAT router X sends a registration reply message containing the session ID to host 14. In this embodiment, the host 12 is a fixed host and the host 14 is a mobile host. Therefore, the mobile host (host 14) may send the registration request message to the NAT router (router X) of the fixed host (host 12).

Refer to FIG. 4. If the mobile host (host 14) moves to a private network (network 10c) behind another NAT router (router Z) during the communication, the mobile host sends another registration request message that contains the session ID from its new address IPb′.Pb′ to the NAT router X again. Because the mobile host is located behind the NAT router Z, the NAT router Z assigns a new mapped address IPz.Pz for the host 14 and relays the message from the address IPz.Pz. The NAT router X will learn from the source IP address and the source port of the registration request message that the new mapped address of the mobile host is IPz.Pz. The NAT router X adds the new mapped address IPz.Pz to the session record associated with the session ID and returns IPz.Pz to the mobile host (host 14) via a registration reply message. Whereby the NAT router X may then relay packets from IPz.Pz to IPa.Pa and the mobile host may learn its new (post-handoff) mapped address is IPz.Pz. Thus, the communication between the host 12 and the host 14 is restored.

The session-aware NAT traversal method proposed by this invention is applied to the case that the mobile host moves from a private network behind a NAT router to another private network behind another NAT router. However, the method of this invention is also applicable to other cases, including the case that the mobile host moves from a public network to a private network behind a NAT router, the case that the mobile host moves from a private network behind a NAT router to a public network, or the case that the mobile host moves from a public network to another public network. Regardless of the cases, the mapped address of the mobile host changes accordingly with the new IP address of the mobile host. The new IP address may either be a public IP address or a private IP address, depending on whether the mobile host moves to a public network or a private network.

In conclusion, this invention proposes a session-aware NAT traversal method. While the mobile host moves to another network, the mobile host needs not to re-conduct NAT traversal but only needs to exchange a pair of messages with the NAT router of the fixed host. The NAT router of the fixed host then allows the mobile host to send packets from the newly mapped address obtained after handoff to the fixed host. Therefore, the invention exempts the mobile host from re-conducting NAT traversal while it is being handed off to another network and shortens the handoff latency of restoring the communication between the mobile host and the fixed host.

The embodiments described above are only to exemplify the invention instead of limiting the scope of the invention. Any equivalent modification or variation according to the characteristic or spirit of the invention is also included within the scope of the invention.

What is claimed is:

1. A session-aware network address translation traversal method, which is applied to network communication between a first host and a second host, wherein the first host is located within a private network behind the first NAT (Network Address Translation) router and the second host is located within either a public network or a private network behind the second NAT router, is comprised of the following steps:
Before communicating, the first host and the second host obtain a first mapped address and a second mapped address respectively; the first host and the second host exchange these mapped addresses to establish a session between each other;
The second host sends a registration request message for this session to the first NAT router; and
The first NAT router creates a session record and assigns a session ID for this session, and then the first NAT router replies a registration reply message to the second host.

2. The session-aware NAT traversal method described within claim 1, wherein the first mapped address contains an IP address and port of the first NAT router.

3. The session-aware NAT traversal method described within claim 1, wherein if the second host is located within a public network, then the second mapped address contains a IP address and a port of the second host, and wherein if the second host is located within a private network behind the second NAT router, the second mapped address contains an IP address and a port of the second NAT router.

4. The session-aware NAT traversal method described within claim 1, wherein the first mapped address is assigned by the first NAT router, and wherein if the second host is located within a public network, then the second mapped address is assigned by the second host, and wherein if the second host is located within a private network behind the second NAT router, the second mapped address is assigned by the second NAT router.

5. The session-aware NAT traversal method described within claim 4, wherein each host sends an echo request message to first type servers in the Internet, and wherein the first type servers then encapsulate the first mapped address into an echo response message and send it to the first host; the first type servers encapsulate the second mapped address into an echo response message and send it to the second host, and wherein the first host and the second host then acquire the first mapped address and the second mapped address respectively.

6. The session-aware NAT traversal method described within claim 5, wherein the first type servers include at least one STUN server.

7. The session-aware NAT traversal method described within claim 1, wherein if the first NAT router and the second NAT router support IGD protocol, the first host and the second host may use the IGD protocol to acquire the first mapped address and the second mapped address from the first NAT router and the second NAT router respectively.

8. The session-aware NAT traversal method described within claim 1, wherein the first host and the second host exchange the first mapped address and the second mapped address through second type servers in the Internet.

9. The session-aware NAT traversal method described within claim 8, wherein the second type servers include at least one signaling server.

10. The session-aware NAT traversal method described within claim 1, wherein the session record created by the first NAT router contains the session ID, the first mapped address and the second mapped address.

11. The session-aware NAT traversal method described within claim 1, wherein the session record created by the first NAT router contains the transport layer protocol used by the session between the first host and the second host.

12. The session-aware NAT traversal method described within claim 1, wherein the registration reply message contains the session ID and the second mapped address.

13. The session-aware NAT traversal method described within claim 1, wherein if the second host acquires a new IP address and a new port as a third mapped address, the method to resume the session between the first host and the second host is comprised of the following steps:
The second host sends a new registration request message containing the session ID to the first NAT router;
The first NAT router adds the third mapped address observed from the packet header of the new registration request message to the session record and then replies a new registration reply message containing the session ID and the third mapped address to the second host; and
The second host acquires the third mapped address and the communication with the first host is resumed.

14. The session-aware NAT traversal method described within claim 13, wherein if the second host acquires a new IP address and a new port as the third mapped address and the second host is located within a public network, the third mapped address contains an IP address and a port of the second host; wherein if the second host is located within a private network behind the third NAT router, the third mapped address contains an IP address and a port of the third NAT router.

15. The session-aware NAT traversal method described within claim 13, wherein if the second host is located within a public network, the third mapped address is assigned by the second host; wherein if the second host is located within a private network behind the third NAT router, the third mapped address is assigned by the third NAT router.
